(19) United States
(12) Patent Application Publication
(10) Pub. No.: US 2003/0010420 A1
(43) Pub. Date: Jan. 16, 2003

(54) Monolithic ceramic laser structure and method of making same

(76) Inventor: Clifford E. Morrow, N. Kingstown, RI (US)

Correspondence Address: GOODWIN PROCTER & HOAR LLP, 7 BECKER FARM RD, ROSELAND, NJ, 07068, US

(21) Appl. No.: 10/100,194

(22) Filed: Mar. 18, 2002

Related U.S. Application Data
(60) Provisional application No. 60/277,025, filed on Mar. 19, 2001.
(60) Provisional application No. 60/350,638, filed on Jan. 23, 2002.

(51) Int. Cl. C03B 29/00; B32B 31/00

(52) U.S. Cl. 156/89.11; 156/257

(57) ABSTRACT

A monolithic ceramic waveguide laser body is made by forming and grinding two or more plates of alumina ceramic to produce internal and external features otherwise impossible to fabricate in a single ceramic body. The plates are bonded together by use of glass frit or by self-friting (diffusion bonding) methods to achieve a vacuum tight enclosure. The ceramic surfaces to be bonded have an “as ground” finish. One internal structure created by this method includes a channel of dimensions from 8 to 1.5 mm square or round that confines an RF or DC electrical discharge and comprises a laser resonator cavity. The channel can be ground to form a “V”, “U” or “Z” shape folded cavity. Another internal structure is a gas reservoir connected to the resonator cavity. Various other important features are described that can only be created by this method of building a laser. The plates are bonded together in a furnace at temperatures ranging between 450° C. and 1700° C., depending on the method used.

### RELATED APPLICATIONS AND CLAIM OF PRIORITY

This application claims the benefit of and incorporates in its entirety herein by reference the contents of the following co-pending applications: Application No. 60/277,025 filed Mar. 19, 2001, entitled “Method of Making a Monolithic Ceramic CO2 Laser Structure” and: Application No. 60/350,638 filed Jan. 23, 2002, entitled “Monolithic Ceramic Laser Structure and Method of Making Same”.

### BACKGROUND OF INVENTION

1. Field of Invention

This invention relates to gas laser technology and in particular to gas lasers constructed of ceramic materials such as Alumina and Beryllia.

2. Description of Prior Art

It is well known that laser cavity structures can be made of a variety of materials as long as vacuum integrity, electrical requirements and dimensional stability are satisfied.

Lasers of aluminum and glass are most common because of the relative ease of forming and machining these materials into the required components.

When considering glass, the ability to mass produce a laser with consistency, cool it without the use of water and protect it from mechanical as well as thermal shock often proves impractical. Metal lasers, as for example the design described in U.S. Pat. No. 5,953,360, are most often made of aluminum, suffer from complexity, as many components need to be installed inside the metal enclosure “ship-in-a-bottle” style adding cost and reducing consistency unit to unit. Aluminum lasers also require adjustable mirror mounts that are often prone to misalignment over time. The laser body defines the optical frame of the laser and if made of aluminum, with its coefficient of expansion 3 times that of alumina, the dimensional stability of the optical cavity can be compromised. Heat extraction from these lasers tends to be asymmetrical causing a slight warp resulting in cavity mirror misalignment. Aluminum and glass lasers also require electrical feed through to bring the excitation power into the enclosure. Feed through can present a reliability issue and add cost.

These complexities and the resulting high unit costs can be avoided by constructing the laser out of plates of alumina that are bonded together.

U.S. Pat. No. 3,982,204 entitled “Laser Tube Discharge Assembly” issued on Sept. 21, 1976 and assigned to Raytheon Company discloses an assembly of two plates of fused quartz or a vitreous material known as “Cer-Vit” with slots formed into one plate to form square channels by covering the first plate with a second. The slots form bores that are optically folded by the use of reflecting mirrors. In this embodiment, the highly polished and cleaned plates are optically contacted together to create a vacuum enclosure with mirrors bonded directly to the assembly. Although this assembly was intended to produce a HeNe ring laser gyroscope, the concept of building a laser from plates can be applied to the CO₂ laser, however with different materials since quartz and Cer-Vit don't allow the efficient removal of heat needed for the CO₂ laser.

U.S. Pat. No. 4,662,958 entitled “Method of Making a Ceramic Evacuatable Enclosure” issued on May 5, 1987 and assigned to The secretary of state for defense in her Britannic Majesty's Government of the United Kingdom of Great Britain and Northern Ireland discloses a very similar laser architecture, substituting alumina for Quartz or Cer-Vit since the purpose of the invention was to build a CO₂ laser. In this embodiment, the alumina was also highly polished to form optical quality surfaces that were clamped together to form an optical contact seal. Heat was applied to cause the two surfaces to fuse together more quickly and with less force than required at room temperature. The alumina was not pure, containing a few percent of vitreous phase material, which wets the alumina surface at elevated temperatures. U.S. Pat. No. 4,662,958 also teaches that under the conditions of optically polished surfaces, (surface roughness of 0.01 to 0.15 microns) there is a relationship between the percentage of vitreous material in the alumina and the minimum temperature required to fuse the plates. The only advantage to the labor and cost of optical polishing was that the plates could be fused at temperatures below the temperature that would cause the alumina to lose dimensional stability.

### SUMMARY OF THE INVENTION

It is one purpose of this invention to describe methods of bonding alumina plates using vitreous phase materials, both added to the ceramic surface and contained within the alumina without the extreme cost and labor required to polish the ceramic surfaces.

It is another purpose of this invention to describe the means by which certain features are pre-formed into the ceramic prior to the bonding so that the resulting structure achieves good performance without the high fabrication cost required by other means.

In the case of bonding two or more plates together, it is well known that alumina with small percentages within the range of 0.2% to 15% of vitreous phase additives will stick together when fired at about 1650° C. without the surfaces being polished. It is also known that the optical properties of alumina, if used within a waveguide structure promote efficient waveguiding in the absence of a high polish at 10.6 μM.

It has been demonstrated that an “as ground” surface finish with a roughness much less than an optical finish (rougher than 1 micron, but better than 10 microns) will support efficient waveguide reflections within a slot formed to waveguide dimensions of between 3.5 mm and 1.5 mm. This same finish can be used on the mating surfaces of the alumina plates. The heating and kiln support requirements to subsequently fuse the alumina plates together will now be higher than in the polished case, however, the cost of this process will be much lower than if the laser halves would need to be polished and very flat over a large area.

Experience has shown that if “as ground” plates of 94% alumina are positioned together, without the additional weight needed in the '958 patent, and fired to a temperature of 1650° C. for 8 hours the plates will fuse together and form a bond that is hermetic and undetectable if the seal is sectioned.

If this high temperature fusing method is used, the ceramic assembly will warp and create a subsequent yield issue. However, to those skilled in the art of ceramic firing, there are methods of arranging the furnace furniture to allow support of the assembly in a way that minimizes the risk of warpage.

It is also possible to bond the two halves of any purity alumina together by applying a very thin layer of glass frit formulated to bond to alumina. Typically this frit is characterized as either a “crystallizing glass” which maintains dimensional stability after cooling or a vitreous glass.

An example of a crystallizing glass frit for alumina is made by KIA, Inc. and Sem-Con called SCC-5 glass. This glass material comes in powder form and must be combined with binders and sprayed or painted onto the alumina surface. Another form of frit glass comes on a tape made by Vitta Corp. The glass powder frit is bound onto a plastic carrier film in tape form. The tape can be cut to a pre-formed shape and attached to the alumina to avoid the problems of potential over spray encountered during the first method. The binders and/or tape will burn off in the firing required to melt the frit onto the alumina. An example of Vitta tape applicable to bonding ceramic is G-1002 vitreous glass tape or G-1014 devitrifying glass tape.

In practice, the frit can be fired onto the ceramic before the two ceramic halves are joining together, before the final firing. By performing a pre firing of the frits the binders that hold the frit to the ceramic can be burned off. This step avoids potential voids in the bond that can be created by the evolution of gases from the binders as they burned off. In the final firing, the glassified surfaces of ceramic are placed face-to-face and remelted into each other creating the final bond.

Alternatively, the frit can be placed on the surfaces, the two halves placed together and fired in a single run if the dimensions of the seal area and the frit used are adjusted to avoid seal voids.

No matter which method is used to bond the two plates together, pre-grinding of the internal surfaces of the alumina plates can create various internal structures. The structures include a gas reservoir, the waveguide channel, communication channels between the reservoir and the waveguide channel and special features that terminate the waveguide prior to reaching the end face of the alumina. These waveguide termination features are important loss mechanisms that allow the laser to discriminate between the fundamental and higher order modes. Low-cost approaches to forming these features are one object of the present invention.

FIG. 1 shows the lower half of the alumina structure containing the lower reservoir region, waveguide channel and the reservoir to waveguide communication channels. In the exemplary embodiment depicted, these features as drawn are made in a way that allows the use of a surface grinder keeping fabrication cost at a minimum. In another embodiment a Branson ultrasonic core drill used can be used as an end mill to create the cross channels.

The upper half of the laser contains the upper half of the reservoir region. Three walls of the waveguide are formed from the slot in the lower plate, while the fourth wall is formed by the as ground surface of the upper plate. A hole is drilled into the reservoir region that receives the valve structure and seal allowing air to be pumped out and the laser mixture to be introduced.

Either before or after sealing the two plates together a set of external slots are formed over the waveguide on each side of the assembly. These slots are intended to receive the RF electrodes and remove heat from the waveguide during operation. The floor of the slot is formed to between 0.030 inches and 0.100 inches of the waveguide, however thicker floors are possible. The object of the thin floor is to improve the efficiency of heat removal that allows the laser to be used in high ambient environments. Additionally, RF pumping of the laser gas through a ceramic wall helps ballast the discharge and removes any chance of arcing. The electrode, being outside of the discharge cannot be oxidized or impact the gas chemistry. Lastly the electrical connections to the electrodes are very easy and inexpensive since there are no feed-through required.

It is a further purpose of the present invention to describe a novel means of attaching a mirror to the laser or other ceramic or metal structure in a way that the mirror is adjustable, provides a vacuum tight seal and is mechanically stable so that temperature changes over long periods of time will not result in drift of the alignment of the mirror face to the waveguide, in the case of a laser, or other reference structures if the mirror mount is used on other optical structures. The basic premise of the mount is based on the concept of a slightly oversized, tapered metal plug acting like a cork pressed into a supporting cylinder that is attached by glue or other means to the optical device, in this case a laser. The plug has attached to the inner end, a mirror that is mounted in a way that the mirror surface is not distorted. The plug also seals to the supporting cylinder by means of an o-ring. The plug is slightly tapered to allow it to be rocked in the cylinder by a jig that temporally attaches to the back of the cylinder. The jig can push on the plug in 4 orthogonal directions to allow angular adjustment. At the same time the plug is driven into the cylinder to an optimal depth where the o-ring engages a shelf to maximize the seal integrity. After the adjustments are complete the alignment jig is removed and the mirror plug cannot be further disturbed. The plug also contains a blind threaded hole to allow removal of the plug if required by using the alignment jig as a pulling tool.

The main advantage of this design over conventional mirror mounts is that the stresses generated by pressing the plug into the cylinder are evenly relieved in the cylinder. As the stress continues to relieve due to time or increase as may be the case when heated, these stresses are evenly distributed in the structure and therefore greatly reducing the chance of mirror misalignment.

Other advantages include; low manufacturing cost due to simplicity of design, ease of making a vacuum seal, compactness and the difficulty for unskilled users to disturb the mirror alignment by accident or deliberately.

The invention will be better understood upon reference to the following detailed description in connection with the accompanying drawings.

### BRIEF DESCRIPTION OF THE DRAWINGS

FIG. 1 shows a diagram of an embodiment of an RF excited laser body.

FIG. 2 shows an assembled unit of the RF type.

FIG. 3 shows two ceramic laser waveguide halves according to the present invention.

FIG. 3a shows an alternate embodiment of two ceramic laser waveguide halves according to the present invention.

FIG. 4 shows a laser waveguide mirror mount according to the present invention.

FIG. 5 shows a diagram of an embodiment of a DC excited laser body.

FIG. 6 shows an embodiment of the present invention having a Slab discharge region.

### DETAILED DESCRIPTION OF SPECIFIC EMBODIMENTS

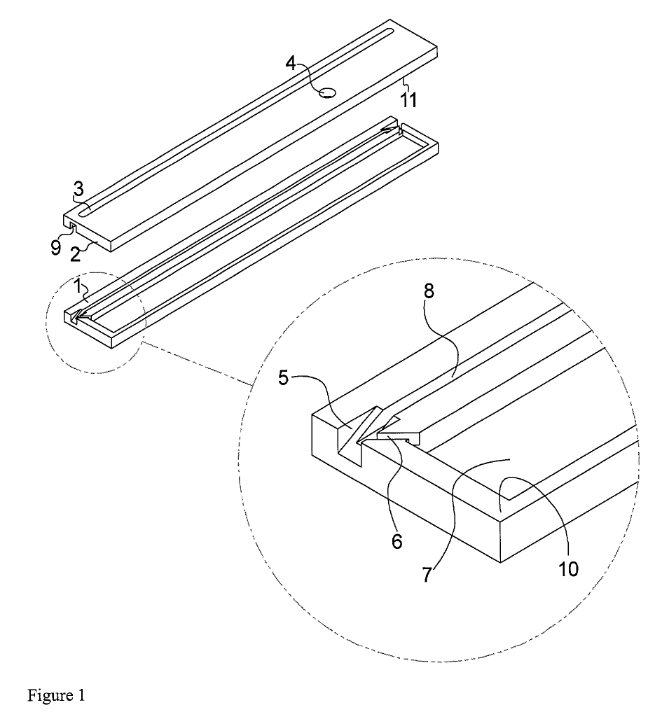

FIG. 1, shows one embodiment of an RF excited laser body assembled from two halves of alumina ceramic 1,2. The lower half is prepared with internal features 5,6,7,8 which can be accomplished by using a surface grinder. Feature 6 is the gas communication channel between the waveguide bore, 8 and the reservoir, 7. The gas communication channel may be angled in such a way as to allow an uninterrupted grinding path from the interior of the reservoir through to the waveguide setback region 5.

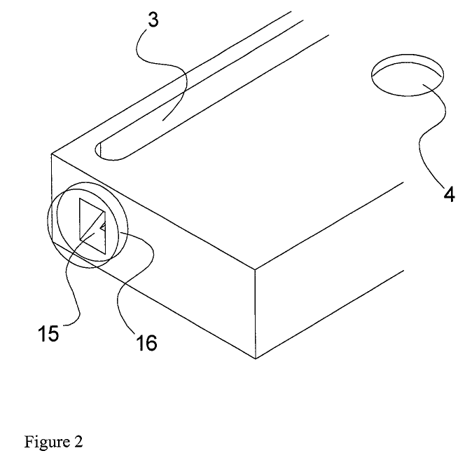

The waveguide setback slot 5 suppresses potential higher order modes from oscillating between the resonator mirrors (not shown). The setback slot 5 may be created by use of a reciprocating surface grinder set to an angle to produce the desired setback and avoid retro reflections from occurring. In particular, in the example shown in FIG. 1 the angle of this slot 5 is not 45° so as to avoid the condition of retroreflection which can result in unintended modes being present within the waveguide. In one embodiment the angle can be the arctangent of the refractive index of a Brewster window positioned to lay on the angled slot 15 between the slot surface and the output coupler 16 in FIG. 2. By inserting a Brewster window, the laser is forced to operate with a polarized output.

For the Brewster window material ZnSe (Zinc Selenide) used in this exemplary embodiment, the refractive index is 2.4. This translates to a slot angle of 67.38 degrees measured from a surface normal to the beam path or 22.62 degrees measured from the path of the beam. The mating half 2, also contains an angled slot 9 that mates with and is opposing the slot 5 making up a cavity when the two halves are mated, with the waveguide entrance recessed back from the end face of the assembly. The angle of this slot is not critical since the recirculating laser beam will not interact with this surface. Alternatively, the setback region can be created by simply counter-boring a cavity after the two laser halves are joined to effectively move the end of the waveguide back from the mirror face.

The mating half 2 (FIG. 1) also has the mating half of the reservoir formed into its underside (not visible) and a communication hole 4 drilled into this reservoir region through which the laser gas mixture can be introduced.

Surface 10 and 11 are prepared with glass frit as described above and accurately mated before firing. Alternatively, surface 10 & 11 are left as ground and mated. In this case the firing will need to reach a higher temperature for fusing to take place and the alumina halves will need proper support to avoid warping as described above. Other means to bond the two halves together are described below.

The slot 3 (FIG. 1) shown in the upper half 2 and a corresponding slot in the lower half 1 contains the RF electrodes. Each slot may be formed either before or after the two halves are bonded. The floor of the slots are formed to within 30 thousandths of an inch or greater of the waveguide wall within, although a thinner floor is possible with the risk of cracks causing leakage of gas.

FIG. 2 shows an assembled unit of the RF type. The output mirror 16 is shown in place. The waveguide setback region 15 is visible through the mirror 16. The slot for the electrode 3 is shown positioned over the waveguide. A valve will be inserted into the hole 4 positioned to break through into the reservoir inside the assembly.

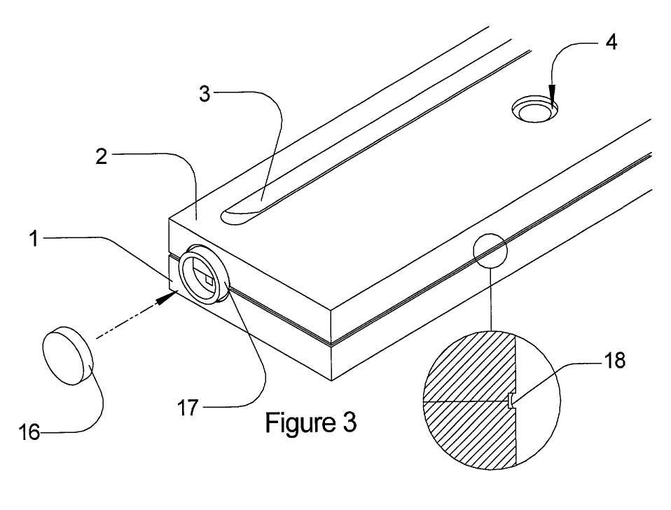

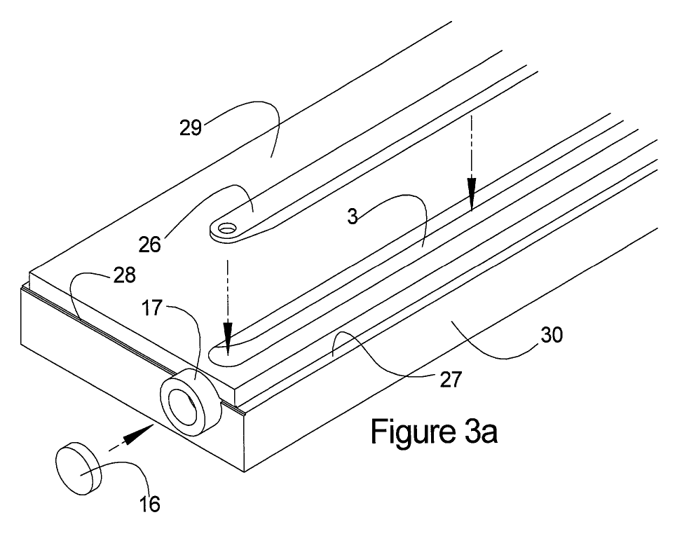

An alternative way to frit the two halves together avoids the difficulties of placing glass frit between the two halves. FIG. 3 shows two ceramic halves circumscribed with a narrow and shallow slot 18 into which is injected a paste of glass frit. The ends of the laser tube where the waveguides emerge are counter bored to allow a small short ceramic ring 17 to be inserted. The frit paste is continued around the ceramic cylinder to finish the seal in a way that does not allow the possibility of glass running into the bore. After firing, the assembly is ground true to the waveguide bore and the exposed end of the cylinder 17 is lapped true to the bore.

It is also possible to use an appropriate grade of epoxy in the slot 18. In this way the expense of the glass firing would be avoided.

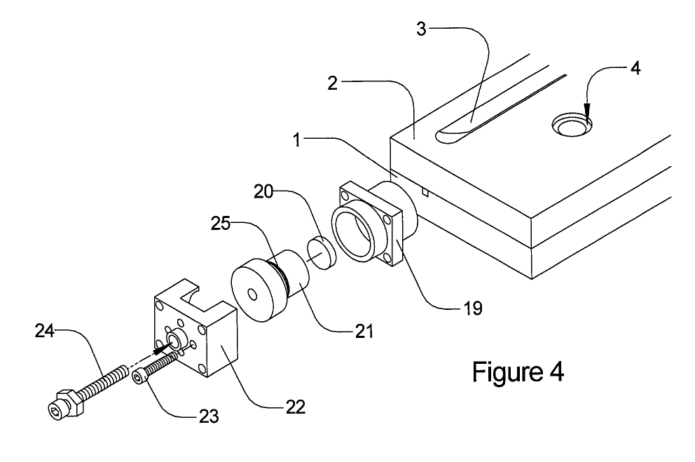

In subsequent assembly steps, the mirror 16 or mirror mount assembly of FIG. 4 is directly bonded to the lapped face of the cylinder 17.

FIG. 3a shows a variation on FIG. 3 where the top plate 29 is a simpler thinner structure with only an electrode slot 3 formed into it. The plate is slightly narrower than the bottom plate 30 which contains the gas reservoir and waveguide slot. Frit is applied along the stepped edge 27 and across the face at 28 as well as around the optic cylinder 17 to make a continuous seal. After firing, the face of 17 is lapped perpendicular to the waveguide and the optic 16 is attached. Electrode 26 is bonded into the floor of the electrode slot 3. This design reduces the cost of the alumina parts.

In FIG. 4 a novel mirror mount is shown that replaces a fixed mirror bonded directly to the alumina body. In an embodiment of the present invention a mirror can be attached to the monolithic structure in alignment with the optical path by bonding the mirror to the structure. However, utilizing this attachment method presents difficulites in that it requires that the bonding surface of the structure be milled to highly accurate tolerances in order to align the mirror to the optical path. Milling to such a high degree of accuracy can be expensive, time consuming and difficult to achieve. Alternately, the mirror can be mounted using an adjustable mount to eliminate the difficulties associated with attaching the mirror by bonding. The adjustable mirror mount is composed of four basic parts 19, 20,21, 22. The flanged cylinder 19, is bonded to the laser body. The rectangular flange is used to attach 22 a temporary jig that aligns the mirror plug 21. The mirror plug is slightly tapered at the large diameter end to allow it to be pressed into 19 by the jig 22 at slight angles if necessary. In one embodiment, this can be accomplished through the use of driving screws 23. The cylinder should be formed of a material having a thermal expansion coefficient that is similar to that of alumina. One such material, although not the only one that can be used in titanium. In addition, the mirror plug should be formed of a material that is either harder or softer such as aluminum or stainless steel. The mirror plug contains a mirror 20 installed into the plug by a means that allows support of the mirror without distortion of the mirror flatness. The mirror plug also includes an O-ring 25 that seals to the flanged cylinder. Angular adjustment of the mirror plug 21 is achieved by nudging the mirror plug with one of four orthogonal driving screws 23 (one of four is shown). The adjustment is followed by backing out the adjusting screw and checking alignment. Screw 24 is used if the plug has been driven in too far and needs removal or the laser optics need servicing. Screw 24 can thread into the mirror plug and used as a puller. The alignment jig 22 is attached to the flanged cylinder 19 by four screws not shown at each corner of the jig.

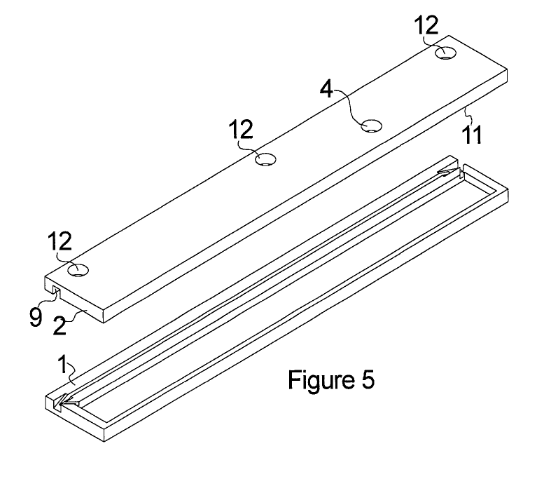

FIG. 5 depicts a ceramic body waveguide according to the present invention wherein DC excitation an alternative to RF excitation is used. The slots 3 (of FIG. 1) are replaced with DC electrode holes 12 as shown. The center hole is an anode and the end holes cathodes or vise versa. DC electrode holes would be needed only in the top half 2 or the assembly.

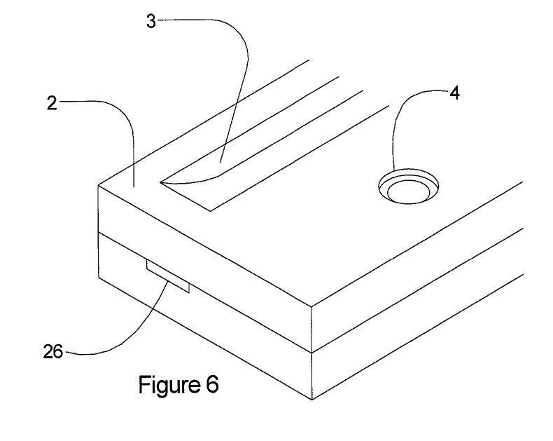

The FIGS. 1 to 5 show an assembly made of two layers and one section of waveguide running the length of the laser body. Other configurations are possible. The optical path of the waveguide can be in the configuration of for example a “V”, “U”, “Z” or there can be two or more separate paths and corresponding optics, creating two or more lasers in one block. In addition, there can be more than two ceramic layers employed to make up the laser body, if for example the optical path needs to be folded in the vertical plane as well as the horizontal plane. FIG. 6 shows another embodiment of the invention where a Slab discharge region 26 is formed within the ceramic body. Previous figures all show waveguide slots 8 (in FIG. 1).

This method of laser construction is not limited to Waveguide optical cavities. Other cavities can be formed including Slab and Free Space. In the example of the Slab, the optical cavity operates in a Waveguide mode in the narrow direction and Free Space in the wide direction. The electrode slot 3 above the cavity must be made wider so the whole volume of the cavity is excited by RF energy. In a similar way, both the cross sectional axes of the optical cavity can be made large enough to create a purely Free Space cavity.

Waveguide lasers are differentiated from Free Space lasers by the Fresnel number. The Fresnel number is defined as:

$$F = \frac{{a}^{2}}{L {λ}_{o}}$$

where a is the beam radius or ½ the waveguide dimension, L is the length of the cavity, and λₒ is the Free Space wavelength of the laser (in the case of a CO₂ laser, 10.59 μM). A Fresnel number less than 0.5 defines a true waveguide cavity and a Fresnel number greater than 10 defines a true Free Space cavity. In a Slab configuration there can be two orthogonal Fresnel numbers.

The invention has now been explained with reference to specific embodiments. In order to avoid unnecessary repetition, it is intended that the variations described in respect of one figure above may also apply to the other figures, either singly or in combination. Other embodiments will be apparent to those of ordinary skill in the art. Therefore, it is not intended that the invention be limited, except as indicated by the appended claims, which form a part of this invention description.

What is claimed is:

1. A method of making a hermetically sealed laser body including the steps of: preparing two or more ceramic body layers each having a mating side with a sealing surface, and joining said sealing surfaces using a bonding material.

2. The method according to claim 1 wherein said two or more ceramic body layers are formed of purity ranging from 0.2% to 15% vitreous phase material.

3. The method according to claim 1 wherein said sealing surfaces have a surface flatness of 1 to 5 thousandths of an inch per foot.

4. The method according to claim 1 wherein said sealing surfaces have a surface roughness of between 1 and 10 microns.

5. The method according to claim 1 wherein said bonding material is glass frit.

6. The method according to claim 5 further including:
firing the body layers at a predetermined temperature to join said sealing surfaces.

7. The method according to claim 1 further including creating internal structures on said mating side.

8. The method according to claim 7 wherein said internal structures are created by grinding and drilling of the ceramic.

9. The method according to claim 7 wherein said internal structures are molded or machined into the ceramic in the green state.

10. The method according to claim 7 wherein the internal structures created include concave regions and optical guides.

11. The method according to claim 1 wherein an optical cavity is formed in said mating side of at least one layer of said ceramic body layer.

12. The method according to claim 11 wherein the aperture of the optical cavity structure is a waveguide.

13. The method according to claim 11 wherein the aperture of the optical cavity structure is a slab.

14. The method according to claim 11 wherein the aperture of the optical cavity structure is a free space cavity

15. The method according to claim 11 further including creating a setback for the optical cavity aperture.

16. The method according to claim 15 wherein creating the setback includes forming a chamfer slot into the ceramic body layer.

17. A method according to claim 16 wherein said chamfer slots are formed at an angle less than 45°.

18. A method according to claim 16 wherein said chamfer slots are formed at an angle greater than 45°.

19. The method according to claim 15 further including forming the set back by counter-boring the ceramic body layer.

20. A method of making a hermetically sealed laser body including the steps of:
preparing two or more ceramic body layers each having a mating side with a sealing surface, and joining said sealing surfaces using a bonding material.

21. The method according to claim 20 wherein said two or more ceramic body layers are formed of purity ranging from 0.2% to 15% vitreous phase material.

22. The method according to claim 20 wherein said sealing surfaces have a surface flatness of 1 to 5 thousandths of an inch per foot.

23. The method according to claim 20 wherein said sealing surfaces have a surface roughness of between 1 and 10 microns.

24. The method according to claim 20 wherein said bonding material is epoxy.

25. The method according to claim 20 further including creating internal structures on said mating side.

26. The method according to claim 25 wherein said internal structures are created by grinding and drilling of the ceramic.

27. The method according to claim 25 wherein said internal structures are molded or machined into the ceramic in the green state.

28. The method according to claim 25 wherein the internal structures created include concave regions and optical guides.

29. The method according to claim 20 wherein an optical cavity is formed in said mating side of at least one layer of said ceramic body layer.

30. The method according to claim 29 wherein the aperture of the optical cavity structure is a waveguide.

31. The method according to claim 29 wherein the aperture of the optical cavity structure is a slab.

32. The method according to claim 29 wherein the aperture of the optical cavity structure is a free space cavity

33. The method according to claim 29 further including creating a setback for the optical cavity aperture.

34. The method according to claim 33 wherein creating the setback includes forming a chamfer slot into the ceramic body layer.

35. A method according to claim 34 wherein said chamfer slots are formed at an angle less than 45°.

36. A method according to claim 34 wherein said chamfer slots are formed at an angle greater than 45°.

37. The method according to claim 34 further including forming the set back by counter-boring the ceramic body layer.

38. A method of making a hermetically sealed laser body including the steps of:
preparing two or more ceramic body layers each having a mating side with a sealing surface, forming a groove on said sealing surface; and
applying glass frit in said groove, and
joining said sealing surfaces.

39. The method according to claim 38 wherein said two or more ceramic body layers are formed of purity ranging from 0.2% to 15% vitreous phase material.

40. The method according to claim 38 wherein said sealing surfaces have a surface flatness of 1 to 5 thousandths of an inch per foot.

41. The method according to claim 38 wherein said sealing surfaces have a surface roughness of between 1 and 10 microns.

42. The method according to claim 38 wherein said bonding material is epoxy.

43. The method according to claim 38 further including creating internal structures on said mating side.

44. The method according to claim 43 wherein said internal structures are created by grinding and drilling of the ceramic.

45. The method according to claim 43 wherein said internal structures are molded or machined into the ceramic in the green state.

46. The method according to claim 43 wherein the internal structures created include concave regions and optical guides.

47. The method according to claim 38 wherein an optical cavity is formed in said mating side of at least one layer of said ceramic body layer.

48. The method according to claim 47 wherein the aperture of the optical cavity structure is a waveguide.

49. The method according to claim 47 wherein the aperture of the optical cavity structure is a slab.

50. The method according to claim 47 wherein the aperture of the optical cavity structure is a free space cavity

51. The method according to claim 47 further including creating a setback for the optical cavity aperture.

52. The method according to claim 51 wherein creating the setback includes forming a chamfer slot into the ceramic body layer.

53. A method according to claim 52 wherein said chamfer slots are formed at an angle less than 45°.

54. A method according to claim 52 wherein said chamfer slots are formed at an angle greater than 45°.

55. The method according to claim 51 further including forming the set back by counter-boring the ceramic body layer.

56. The method of making a hermetically sealed laser body including the steps of:
preparing two or more ceramic body layers each having a mating side with a sealing surface, and
forming a plurality of distinct regions having a boundary on said mating side of at least one of said ceramic body layers, and
connecting at least two of said distinct regions by forming at least one slot between said regions.
joining said sealing surfaces using a bonding material

57. The method of claim 56 further including connecting said distinct regions by removing a portion of said boundary.

58. The method according to claim 1 further including aligning said ceramic body layer exterior sides with the optical cavity within.

59. A method according to claim 42 wherein said epoxy is applied in a groove circumscribed in said sealing surface.

60. A method according to claim 1 further including forming a slot on the outer surface of said ceramic body.

61. The method of claim 60 wherein each slot is formed to a depth that leaves a wall of ceramic between 0.010 and 0.100 thick between the internal waveguide and the slot.

62. A method according to claim 1 wherein after the layers are sealed together, a hole is drilled into the region defined as the gas reservoir.

63. A method according to claim 62 wherein the hole is sealed by a valve assemble or other hermitic seal method.

64. A method according to claim 60 wherein the slots receive a set of electrodes made of a material that conducts well both RF current as well as heat.

65. A method according to claim 64 wherein the electrodes are bonded to the floor of the slot by electrically and thermally conductive epoxy.

66. A method according to claim 64 wherein the electrodes are attached to heat sinks to remove heat.

67. A method according to claim 1 further including:
bonding the said sealing surfaces with a plastic glue,
supporting said ceramic body layers on a surface flat and rigid surface,
firing said ceramic body layers to a temperature between 1600° C. and 1700° C. for a predetermined time sufficient to fuse the layers together.
cooling said ceramic body,
grinding the sealed together ceramic body layers to true up the faces and assure they are true to the optical cavity within.

68. A monolithic ceramic laser structure according to claim 1 further including a mirror structure that achieves permanent alignment along the optical path of the beam to be intercepted and reflected comprising;
a flanged smooth walled cylinder for bonding to the laser body,
a mirror bearing plug in interference fit with said smooth walled cylinder,
a temporary jig for aligning the mirror plug,

69. A monolitic ceramic laser structure according to claim 68 further including at plurality of driving screws for moving said jig along the axis of each of said driving screws.

69. The structure according to claim 68 wherein said cylinder is formed from material having a thermal coefficient of expansion similar to alumina

70. The structure according to claim 68 wherein said cylinder is formed from material harder than said plug.

71. The structure according to claim 68 wherein said cylinder is formed from material softer than said plug.

72. The structure according to claim 68 wherein the plug wall is tapered.

73. The structure according to claim 68 wherein the plug is sealed to the cylinder wall by an O-ring.

74. The structure according to claim 68 further including a mounting bracket

74. A method of making a hermetically sealed laser body according to claim 56, further including forming said at least one slot by;
selecting a portion of said boundary separating one of said distinct regions from a waveguide setback slot,
positioning a grinder to remove said portion of said boundary in an uninterrupted cut at a constant depth such that the grinding wheel does not contact any other portion of said sealed laser body.

75. The method according to claim 67 wherein said flat and rigid surface has a surface flatness of 1 to 5 thousandths of an inch per foot throughout the entire heat cycle

76. The method according to claim 5 further including:
firing the body layers at a predetermined temperature prior to joining said sealing surfaces, and
performing a second firing at a predetermined temperature after joining said sealing surfaces.
